(19) United States
(12) Patent Application Publication
(10) Pub. No.: US 2010/0060804 A1
(43) Pub. Date: Mar. 11, 2010

(54) Projection Type Display Device

(75) Inventors: Hidekazu Masukawa, Saitama (JP); Tatsuhiko Ikehata, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/392,906

(22) Filed: Feb. 25, 2009

(30) Foreign Application Priority Data
Sep. 10, 2008 (JP) 2008-231749

(51) Int. Cl. H04N 9/31; G10L 11/00

(52) U.S. Cl. 348/744; 704/274; 348/E09.025; 704/E11.001

(57) ABSTRACT

A projection type display device 1 includes a memory portion 12C for storing a voice guide data 120 recorded preliminarily, associating the voice guide data 120 with the use situation; a voice reproducing portion 12B for reproducing the voice guide data 120; a light source driving portion 13, a light source 14, a liquid crystal panel 15, a lens 16 and a liquid crystal panel driving portion 17 as an image display portion for displaying images by projection; and a control portion for detecting the use situation of each portion, and simultaneously if the voice guide data 120 corresponding to the use situation exists, for obtaining the voice guide data 120 corresponding to the use situation from the memory portion 12C and for reproducing it in the voice reproducing portion 12B.

The present application is based on Japanese patent application No. 2008-231749, the entire contents of which are incorporated herein by reference.

### BACKGROUND

1. Field

One embodiment of the invention relates to a projection type display device.

2. Description of the Related Art

Heretofore, in a projection type display device such as a projector, there has been known a display device, if an abnormal situation occurs such as a lamp burnt-out in which an image can not be displayed, which informs the user about the abnormal situation by blinking of LED indicator, output of beep sound and the like.

However, in the conventional projection type display device, there is a problem that although it can inform the user about the abnormal situation, it can not inform about a coping process of the abnormal situation, a concrete content of the abnormality and the like.

As the device for solving the above-mentioned problem, there has been known a projection type display device which detects the abnormal situation and informs the user by voice (for example, refer to JP 2000-292857 A1).

This projection type display device includes a detecting portion for detecting an abnormal situation such as a lamp burnt-out, a voice reproducing portion for reproducing a voice information recorded preliminarily, and a control portion for reproducing the voice information corresponding to the abnormal situation in the voice reproducing portion when the abnormal situation is detected in the detecting portion, and for example, by that the device guides a procedure of the lamp replacement by voice, the user can easily cope with the lamp burnt-out.

However, in the conventional projection type display device, there is a problem that although the display device can detect the abnormal situation such as a lamp burnt-out, a lamp temperature anomaly and a cooling fan anomaly by the detecting portion and can reproduce the voice information corresponding to the abnormal situation, it can not inform the user about the device condition, in the situation that any images can not be displayed in ordinary use without failure, such as during preparation of the lamp turning on, after the lamp turning off, and during the system starting up.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic view showing a constitution example of a projection type display device according to a first embodiment of the invention;

FIG. 2 is a block diagram showing a constitution example of a projection type display device according to a first embodiment of the invention;

FIG. 3 is a schematic view showing a content example of a voice guide data of a projection type display device according to a first embodiment of the invention;

FIG. 4 is a schematic view showing a display example of a projection type display device according to a first embodiment of the invention;

FIG. 5 is a schematic view showing a display example of a projection type display device according to a first embodiment of the invention;

FIG. 6 is a schematic view showing a display example of a projection type display device according to a first embodiment of the invention;

FIG. 7 is a flow chart showing an operation example of a projection type display device according to a first embodiment of the invention;

FIG. 8 is a flow chart showing an operation example of a projection type display device according to a first embodiment of the invention;

FIG. 9 is a flow chart showing an operation example of a projection type display device and a personal computer according to a second embodiment of the invention;

FIG. 10 is a flow chart showing an operation example of a projection type display device according to a second embodiment of the invention.

### DETAILED DESCRIPTION OF PREFERRED EMBODIMENTS

Various embodiments according to the invention will be described hereinafter with reference to the accompanying drawings.

(1) According to one embodiment of the invention, there is provided a projection type display device, including: an image display portion for displaying images by projection; a memory portion for storing a voice information recorded preliminarily, associating the voice information with an use situation; a voice reproducing portion for reproducing the voice information; and a control portion for detecting an use situation of each portion, and simultaneously if the voice information corresponding to the use situation exists, for obtaining the voice information corresponding to the use situation from the memory portion and reproducing the information in the voice reproducing portion.

According to the constitution as described above, by reproducing the voice information corresponding to the use situation of the device, the use situation thereof can be informed to the user by voice even if the use situation thereof can not be informed to the user by display.

(2) According to a further embodiment of the invention, there is provided a projection type display device, including: an image display portion for displaying images by projection; a memory portion for storing a voice information recorded preliminarily, associating the voice information with an use situation; a voice reproducing portion for reproducing the voice information; and a control portion for detecting an use situation of each portion if it judges that the image display portion is in a state of not being able to display the images, and simultaneously if the voice information corresponding to the use situation exists, for obtaining the voice information corresponding to the detected use situation from the memory portion and reproducing the information in the voice reproducing portion.

According to the constitution as described above, by that the voice information is reproduced dependent on the use situation of the device, the use situation thereof can be informed to the user by voice even if the use situation thereof can not be informed to the user by display on the ground that the image display portion can not display the image.

According to a projection type display device of the invention, the device condition can be informed to the user even if in the situation that the image can not be projected.

Hereinafter, a projection type display device according to an embodiment of the invention will be described in detail with reference to the accompanying drawings.

### First Embodiment

### Construction of Projection Type Display Device

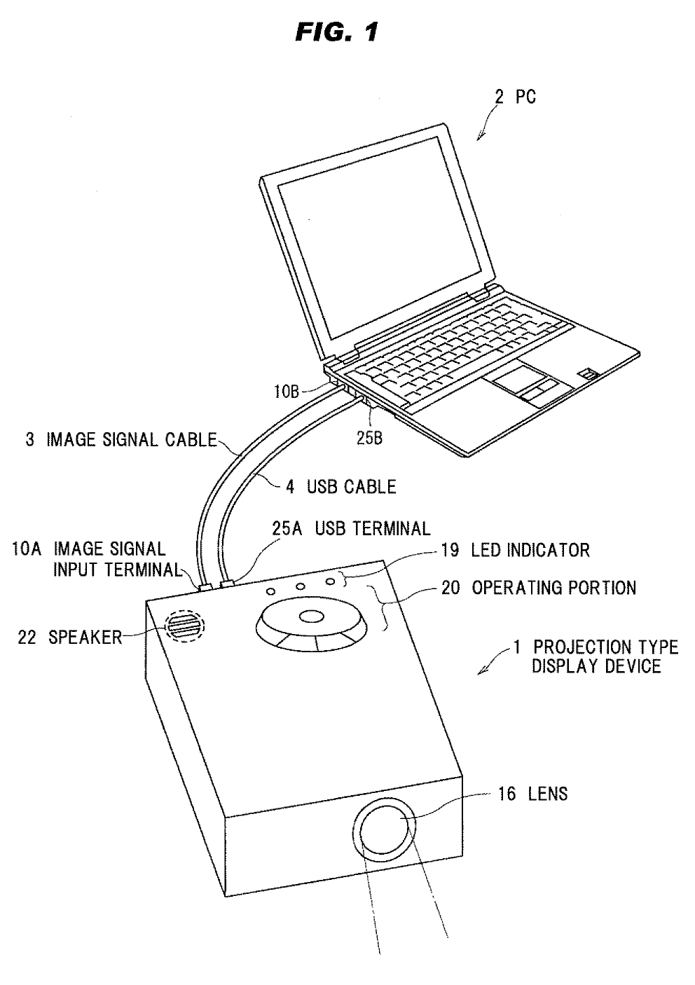

FIG. 1 is a schematic view showing a constitution example of a projection type display device according to a first embodiment of the invention.

A projection type display device 1 is connected to a personal computer (PC) 2 for outputting an image signal, a control signal and the like externally through an image signal cable 3 for transmitting the image signal and a USB (Universal Serial Bus) cable 4 for transmitting the control signal and the like, and the device 1 performs a signal processing of the image signal received from the PC 2, emits a lens (16) projection light and displays the projection image on a screen (not shown). Further, as an intermediate cable for transmitting the control signal and the like by connecting between the projection type display device 1 and the PC 2, RS232 cable and the like can be used as well as the USB cable 4, and the device 1 can be connected to the PC 2 via a network connected to a router and the like by a network cable.

The projection type display device 1 includes an image signal input terminal 10A to which the image signal is inputted from the PC 2 through the image signal cable 3, a lens 16 installed on the front surface of the device for emitting a projection light, a LED (Light Emission Diode) indicator 19 installed on the upper surface of the device for informing the device condition, an operating portion 20 composed of a plurality of switches used for conducting various operations such as a power-on operation and a brightness adjustment operation, a speaker 22 for outputting voices and a USB terminal 25A through the USB cable 4.

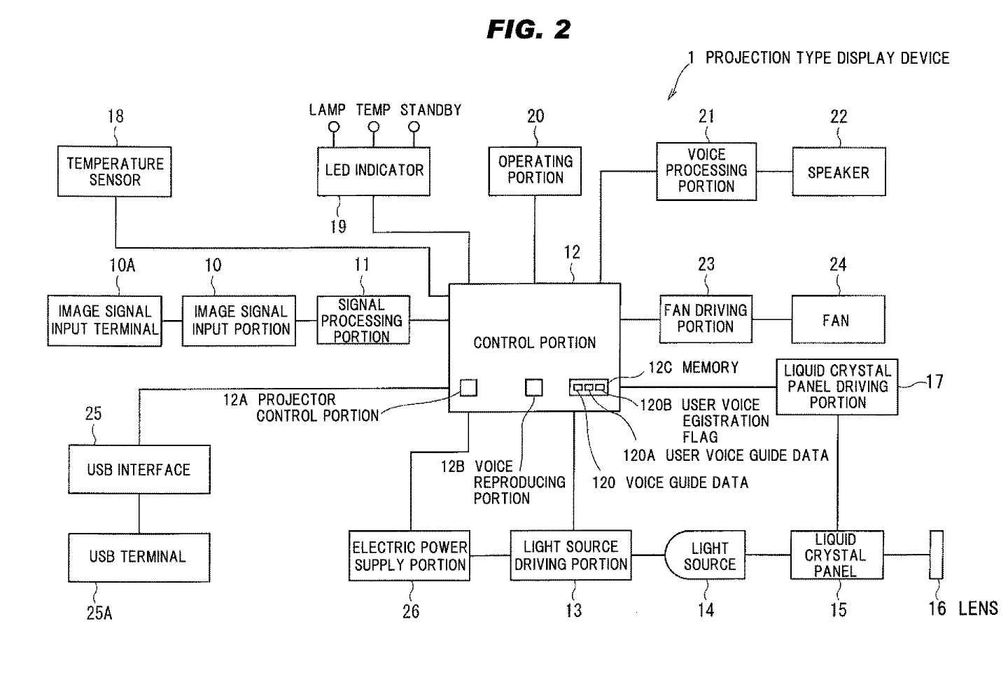

FIG. 2 is a block diagram showing a constitution example of a projection type display device according to a first embodiment of the invention.

The projection type display device 1 includes an image signal input portion 10 for inputting an image signal through the image signal input terminal 10A, a signal processing portion 11 for performing a conversion processing so as to convert the image signal inputted from the image signal input portion 10 to a projection image and a control portion 12 for controlling each portion.

Further, the projection type display device 1 includes, as an image display portion, a light source driving portion 13 for controlling a starting operation, an ending operation, and a driving operation of alight source 14, the light source 14 such as a mercury lamp, a LED, or a laser, a liquid crystal panel 15 through which an emission light from the light source 14 is optically transmitted, thereby producing a projection light, a lens 16 having a focusing mechanism portion for adjusting a focus of the projection light and a liquid crystal panel driving portion 17 for performing a display control of the liquid crystal panel 15. Further, a DLP (Digital Light Processing) projector system using DMD (Digital Micromirror Device) can also be used as well as the system using the liquid crystal panel 15 as the image display portion.

Further, the projection type display device 1 includes a temperature sensor 18 plurally installed in the main unit for measuring a temperature, a LED indicator 19 for informing a lamp burnt-out of the light source 14, a temperature anomaly or a standby situation respectively by lighting up and an operating portion 20 composed of a plurality of switches for outputting an operation signal dependent on each operation.

Furthermore, the projection type display device 1 includes a voice processing portion 21 for controlling, such as for amplifying, the voice signal, a speaker 22 for outputting a voice, a fan driving portion 23 for driving a fan 24 under control of the control portion 12, a fan 24 plurally installed in the main unit, a USB interface 25 for inputting and outputting an information to the PC 2 through the USB terminal 25A and an electric power supply portion 26 for supplying electric power to each portion.

The control portion 12 includes a projector control portion 12A for controlling an output operation of a projection light, a voice reproducing portion 12B for detecting a situation of each portion and reproducing after decoding the voice data dependent on the situation, and a nonvolatile memory 12c as a memory portion for storing a voice guide data 120 and a user voice guide data 120A. The voice guide data 120 includes a voice data composed of a plurality of languages corresponding to a situation of each portion. The user voice guide data 120A is a voice data to be recorded by the user.

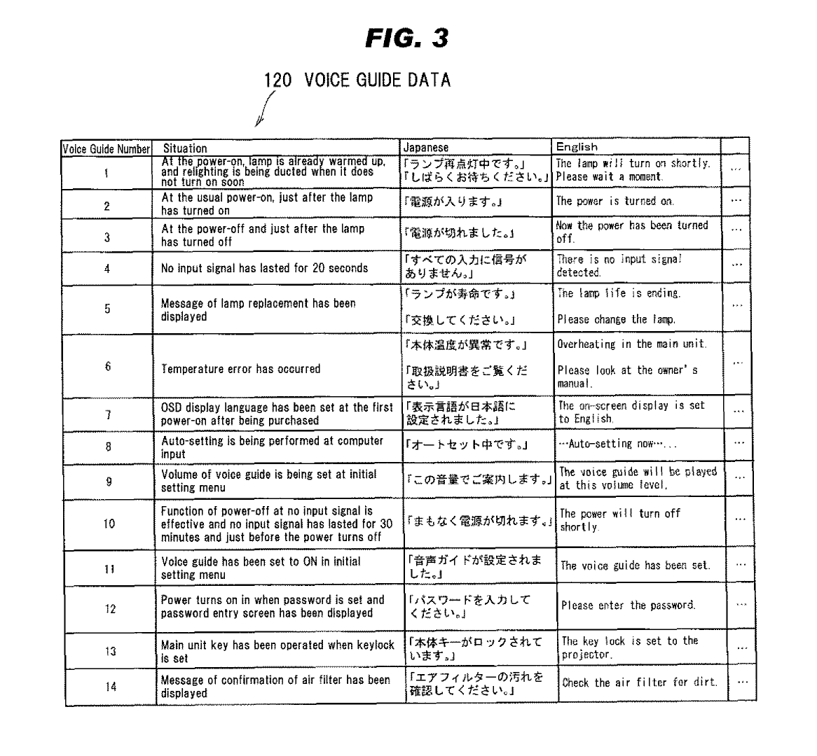

FIG. 3 is a schematic view showing a content example of a voice guide data of a projection type display device according to a first embodiment of the invention.

The voice guide data 120 includes voice guide numbers given arbitrary figures, a situation of each portion detected by the voice reproducing portion 12B and a voice data in languages such as Japanese, English and the like. Then, the contents of the voice data are represented by letters, but actually the voice data are the data saved in formats such as WAV and MP3.

The voice guide numbers “1” and “2” are voice data to be outputted just after power-on operation of the projection type display device 1 and in the preparation situation that the image projection is prepared. Namely, this is the situation that the information can not be visually shown to the user.

The voice guide number “1” is used in the situation that the lamp is already warmed up at the power-on operation of the projection type display device 1, and a cooling time is required for relighting, and the voice data whose content is “The lamp will turn on shortly. Please wait a moment” is reproduced.

The voice guide number “2” is used in the situation that the lamp is being warmed up at the power-on operation of the projection type display device 1, and the voice data whose content is “The power is turned on” is reproduced.

Further, the voice guide numbers “3” and “4” are voice data to be outputted after stopping use of the device 1 and in the situation that the image projection is ended. Namely, this is the situation that the information can not be visually shown to the user.

The voice guide number “3” is used in the situation that the power of the projection type display device 1 has been turned off, and the voice data whose content is “Now the power has been turned off” is reproduced.

The voice guide number “4” is used in the situation that the input signal to the projection type display device 1 is not detected for predetermined time, for example, for 20 seconds, and the voice data whose content is “There is no input signal detected” is reproduced.

Further, the voice guide numbers “5” and “6” are voice data to be outputted in the situation that the projection type display device 1 can not project the image normally. Namely, this is the situation that the information can not be visually shown to the user, and an abnormality has occurred in the projection type display device 1.

The voice guide number “5” is used in the situation that the lamp replacement is required, and the voice data whose content is “The lamp life is ending. Please change the lamp” is reproduced.

The voice guide number “6” is used in the situation that the temperature in each portion of the projection type display device 1 is abnormal, and the voice data whose content is “Overheating in the main unit. Please look at the owner's manual” is reproduced.

Further, the voice guide numbers “7” to “14” are voice data to be outputted in the situation that the projection type display device 1 is during use and during projection of the images, or voice data corresponding to OSD (On Screen Display, as described later).

The voice guide numbers “7” to “9”, “11” and “13” are voice data to be used as a response to the fact that the operation has been performed to the OSD, and the voice guide numbers “10”, “12” and “14” are voice data to be outputted dependent on the OSD displayed. Further, the voice guide data 120 as shown in FIG. 3 is one such example, and other situations and contents can also be set up.

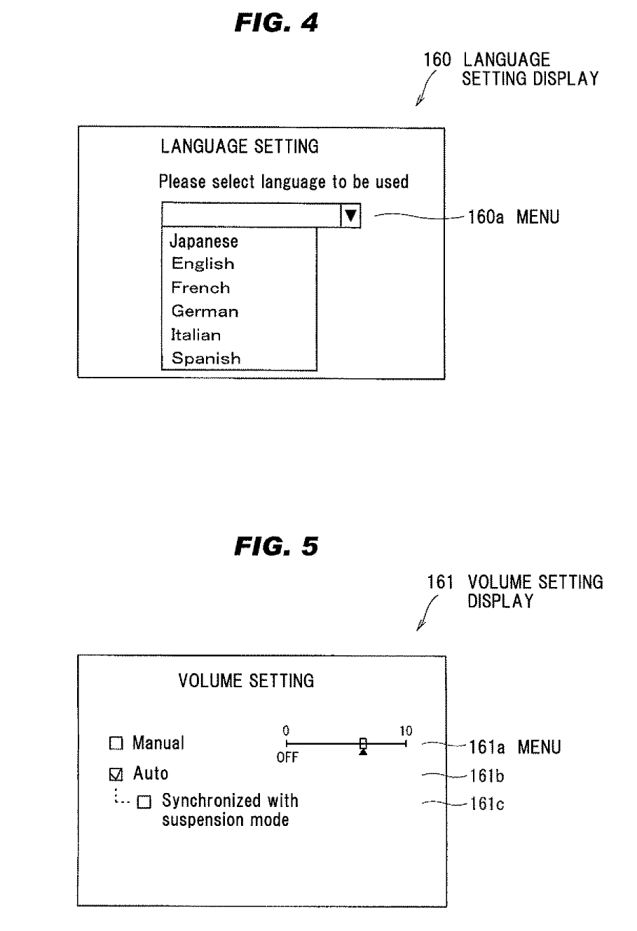

FIG. 4 is a schematic view showing a display example of a projection type display device according to a first embodiment of the invention.

In FIG. 4, a language setting display 160 is one example of the OSD to be displayed on the projection image so as to be overlapped with the image by the projector control portion 12A, and a menu for selecting the language to be used on the OSD. Further, the language setting display 160 is displayed on the first start-up of the projection type display device 1, or in a case that the user has inputted an operation for changing the language setting.

Usually, since in most cases, it is convenient that the language used in the OSD is identical to one used in the voice guide, if the language to be used in the OSD is set up by the language setting display 160, in conjunction with this, the language to be used in the voice guide is set up at the same time. Further, the languages used in the OSD and the voice guide can also be set up so as to be differentiated from each other.

Further, the language setting display 160 includes a menu 160a of pull-down type for selecting each language. By the menu 160a, the language to be used on the OSD such as “Japanese”, “English”, “French”, “German”, “Italian”, and “Spanish”, is selected and simultaneously the language to be used in the voice guide is selected. Further, the selected setting (not shown) is saved on the memory 12C.

FIG. 5 is a schematic view showing a display example of a projection type display device according to a first embodiment of the invention.

A volume setting display 161 is an OSD to be displayed on the projection image by the voice reproducing portion 12B, and includes a menu 161a displayed as “Manual” for setting up the volume setting manually, a menu 161b displayed as “Auto” for setting up the volume setting automatically, and a menu 161c displayed as “Synchronized with Suspension Mode” for being “Synchronized with Suspension Mode”, when the volume is set up automatically. Further, the selected setting(not shown) is saved on the memory 12C.

The term “Auto” here means a setting for changing the volume dependent on the driving condition of the fan driving portion 23, and if the fan is not driven the volume is decreased, and if the fan is driven the volume is increased in proportion to the driving level. Further, the setting can also be adopted, that the volume is changed dependent on ambient noise by additionally installing microphone and the like as well as dependent on the driving condition of the fan driving portion 23.

Further, the term “Suspension Mode” means an operation mode for suspending the projection type display device 1 from the ceiling upside down and displaying the projection image which is turned by 180 degrees. In the Suspension Mode, since the projection type display device 1 is located apart from the user, as one example, the volume is enlarged in comparison with the case that the setting is set to ordinary “Auto”.

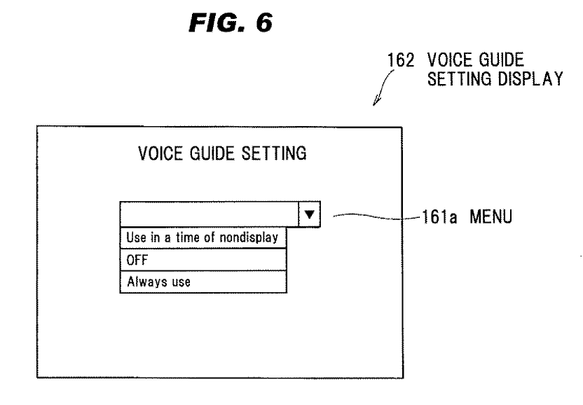

FIG. 6 is a schematic view showing a display example of a projection type display device according to a first embodiment of the invention.

A voice guide setting display 162 is an OSD to be displayed on the projection image by the voice reproducing portion 12B, and includes a menu 162a for selecting use conditions of the voice guide. In case of an operation mode “Use in a Time of Nondisplay”, the voice reproducing portion 12B reproduces the voice guide to the user, when the projection image is not displayed, and the information can not be visually shown to the user, including an abnormal situation of the projection type display device 1 (the voice guide numbers: “1” to “4”, and “5” to “6”), and in case of “OFF”, all the voice guides are not used. Further, in case of “Always Use”, in addition to the above-mentioned A TIME OF NONDISPLAY (the voice guide numbers: “1” to “6”) the voice reproducing portion 12B reproduces the voice guide to the user and guides the operation of the user, when the projection image is displayed, and the information can be visually shown to the user (the voice guide numbers: “7” to “14”). That is, all the voice guides are reproduced. Further, the selected setting(not shown) is saved as the voice reproduction setting for determining the operation mode of the voice reproducing portion 12B on the memory 120.

### Operation of Projection Type Display Device

An operation of the projection type display device according to the first embodiment of the invention will be described in detail hereinafter with reference to each drawing.

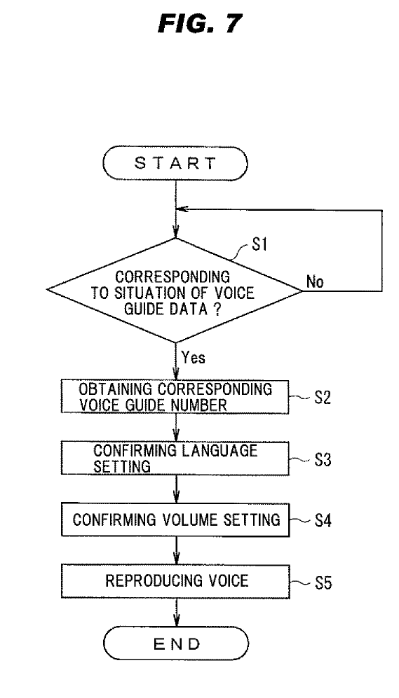

FIG. 7 is a flow chart showing an operation example of a projection type display device according to a first embodiment of the invention.

First, the voice reproducing portion 12B monitors the situation of each portion, and when it detects the situation corresponding to the situation of the voice guide data 120 (Step S1; Yes), it obtains the corresponding voice guide number (Step S2).

Next, the voice reproducing portion 12B accesses the memory 12C, confirms the language setting (Step S3) and the volume setting (Step S4), and reproduces the voice guide data of the corresponding voice guide number in the selected language, based on the volume setting which is already set up (Step 5).

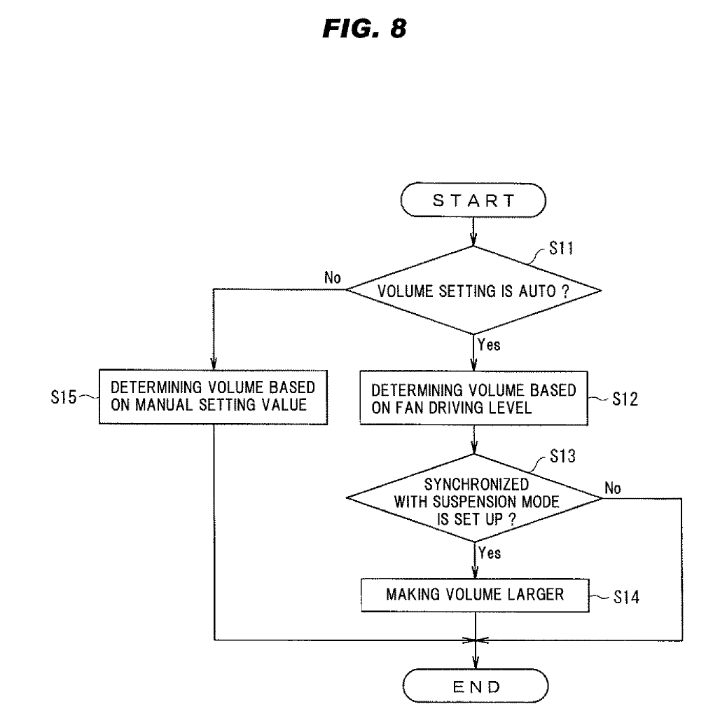

FIG. 8 is a flow chart showing an operation example of a projection type display device according to a first embodiment of the invention, and describes in detail Steps S4 and S5 described in FIG. 7.

The voice reproducing portion 12B accesses the memory 12C, thereby confirming the volume setting (Step S3), and when the volume setting is Auto (Step S11; Yes) it determines the volume based on the fan driving level of the fan driving portion 23 (Step S12).

Next, when Synchronized with Suspension Mode is set up (Step S13; Yes), the volume is made larger by predetermined value, for example 10 dB, than the volume in the setting of Auto (Step S14). When Synchronized with Suspension Mode is not set up (Step S13; No), the voice guide data is reproduced at the volume of the setting of Auto.

Further, when the volume setting is manual (Step S11; No), the voice guide data is reproduced at the volume which the user sets up (Step S15).

According to the above-mentioned embodiment of the invention, by that a setting item other than OFF is selected as the voice guide setting, the device condition, the operation process or the like can be informed to the user by the voice guide at least in the situation that the image can not be projected.

Further, by that the volume setting is set to Auto, the volume setting in consideration of noise based on fan and the like and the Suspension Mode can be realized.

### Second Embodiment

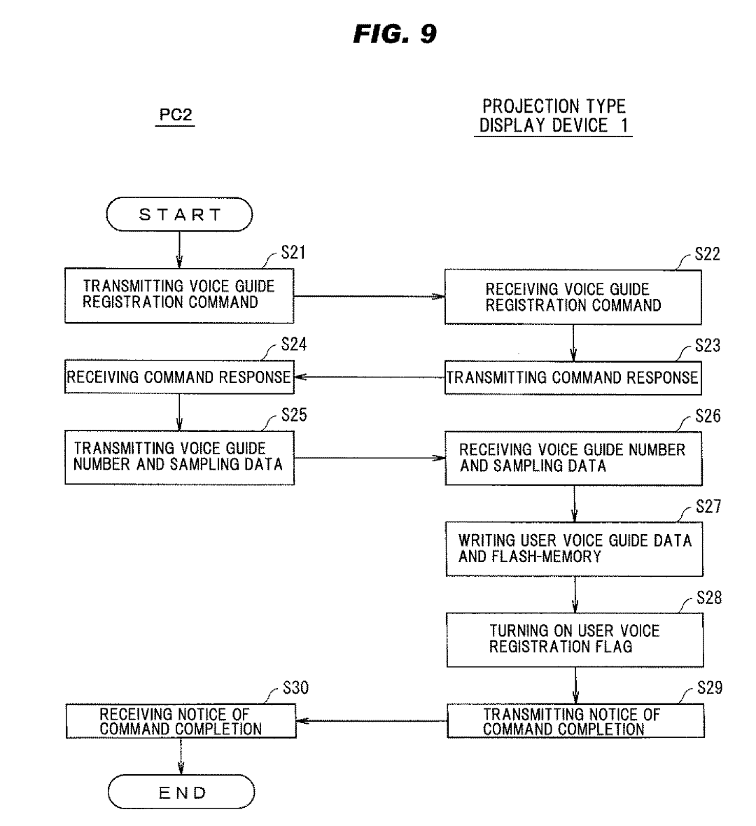

FIG. 9 is a flow chart showing an operation example of a projection type display device and a personal computer according to a second embodiment of the invention. Further, in the following explanation, as to a part comprising the same composition and function as used in the first embodiment, the same references are used.

First, sampling data are prepared in the PC 2 and a voice guide registration command is transmitted to the projection type display device 1 through the USB cable 4 (Step S21), the voice guide registration command showing demand for registering the prepared sampling data to the projection type display device 1 as an user voice guide data.

Further, the sampling data can be prepared by the voice of user which is recorded by use of a built-in microphone of the PC 2, an external microphone or the like, and by an existent data such as WAV, MP3 or the like are edited. Furthermore, when the sampling data are registered as the user voice guide data, it is necessary to designate the voice guide number (the voice guide data 120 as shown in FIG. 3) in order to define the timing of reproduction.

Next, the projection type display device 1 receives the voice guide registration command (Step S22), and transmits a command that the voice guide registration is allowed as a command response to the PC 2 (Step S 23).

Next, when the PC 2 receives the command response (Step S24), the PC 2 transmits the sampling data correspondingly provided with the voice guide number to the projection type display device 1 (Step S25).

Next, the projection type display device 1 receives the voice guide number and the sampling data (Step S26), and writes the sampling data on the memory 12C as the user voice guide data 120A (Step S27). Further, the voice guide data 120 and the user voice guide data 120A are written on different storage area respectively, so that the voice guide data 120 is not overwritten by the writing of the user voice guide data 120A.

Next, the user voice registration flag 120B turns ON in order to use the written user voice guide data 120A (Step 328), a notice of command completion showing registration completion is transmitted to the PC 2 (Step S29).

The PC 2 receives the notice of command completion (Step S30), and the operation of voice guide data registration is completed.

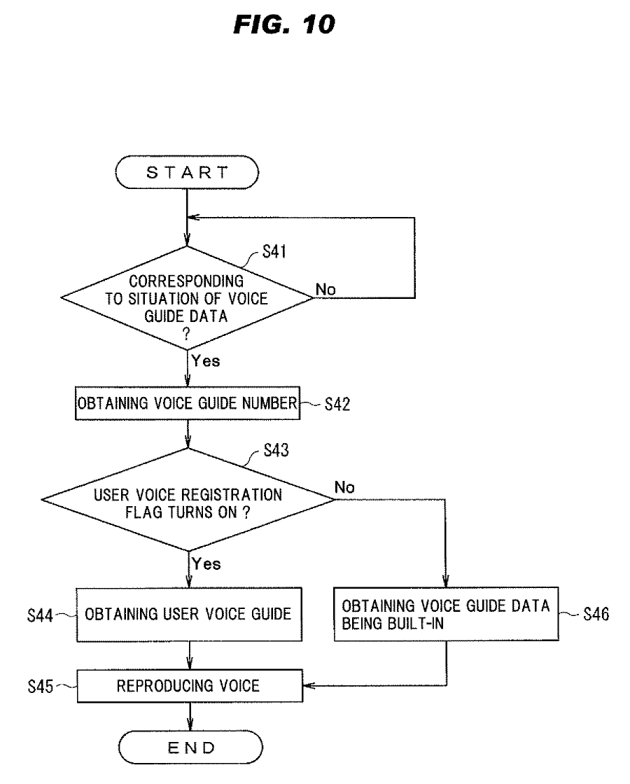

FIG. 10 is a flow chart showing an operation example of a projection type display device according to a second embodiment of the invention.

First, the voice reproducing portion 12B monitors the situation of each portion, and when it detects the situation corresponding to the situation of the voice guide data 120 (Step S41; Yes), it obtains the corresponding voice guide number (Step S42).

Next, the voice reproducing portion 12B accesses the memory 12C, and confirms that the user voice registration flag 120B is turned ON (Step S43), and If ON (Step S43; Yes), obtains the user voice guide 120A (Step S44) and reproduces the voice guide information of the corresponding voice guide number based on the volume setting which is already set up (Step S45). Further, if OFF (Step S43; No), obtains the voice guide data 120 being built-in (Step S46), and reproduces the voice guide information of the corresponding voice guide number based on the volume setting which is already set up (Step S45).

According to the above-mentioned embodiment of the invention, by that the sample data is registered to the projection type display device 1 from the PC 2, a desired sample data can be used for the voice guide information, and the device condition, the operation process or the like can be informed to the user by the user voice guise 120A at least in the situation that the image can not be projected.

Note that, in the above-mentioned embodiment, the voice guide data 120 relating to all the languages being usable is saved on the memory 12C and the voice guide data to be used is selected, but the invention is not limited to the above. For example, the constitution can also be adopted, that the voice guide data of each language being usable is saved on the recording media such as CD-ROM, and the voice guide data of the desired language is registered from the recording media such as CD-ROM by use of the PC 2. In this case, the voice guide data to be registered can be plural. Consequently, the capacity of the memory 12C required for the saving of the voice guide data can be decreased in comparison with the case that the voice guide data of all the languages are preliminarily registered.

Further, as the user voice guide data 120A the sampling data such as music and sound effect as well as guiding voice can also be set up. And, the constitution can also be adopted, that the image displayed in conjunction with the voice guide data 120 or the user voice guide data 120A, for example an image data such as corporate logo and illustration can be registered. In this case, by that the data to be registered are registered dependent on the voice guide number, sounds such as music and sound effect and image data can be outputted along with the voice guide.

It is noted that the present invention is not limited to the embodiments described above and various changes can be made without departing from or changing the technical idea of the present invention.

What is claimed is:

1. A projection type display device, comprising:
an image display portion for displaying images by projection;
a memory portion for storing a voice information recorded preliminarily, associating the voice information with an use situation;
a voice reproducing portion for reproducing the voice information; and
a control portion for detecting an use situation of each portion, and simultaneously if the voice information corresponding to the use situation exists, for obtaining the voice information corresponding to the use situation from the memory portion and reproducing the information in the voice reproducing portion.

2. A projection type display device according to claim 1, wherein the control portion changes a reproducing volume of the voice information reproduced in the voice reproducing portion dependent on the driving situation of a fan for cooling the image display portion.

3. A projection type display device according to claim 1, wherein the control portion detects a volume of ambient noise and changes a reproducing volume of the voice information reproduced in the voice reproducing portion dependent on the volume of ambient noise.

4. A projection type display device according to claim 1, wherein the memory portion having the voice information of plural languages, and the control portion, when it obtains the voice information of plural languages from the memory portion, obtains a voice information of the language selected by language setting in OSD (On Screen Display) which the image display portion displays so as to be overlapped with the images.

5. A projection type display device according to claim 1, wherein the memory portion stores the voice information received from the outside, associating the voice information with the use situation.

6. A projection type display device according to claim 1, wherein the memory portion stores the voice information associated with the preparatory state of the image display portion.

7. A projection type display device according to claim 1, wherein the memory portion stores the voice information associated with the ending state of the image display portion.

8. A projection type display device according to claim 1, wherein the memory portion stores the voice information associated with the existence or nonexistence of the input signal of the image display portion.

9. A projection type display device according to claim 1, wherein with regard to the voice information reproduced in the voice reproducing portion, and as the use situation, the control portion operates depending on one operation mode selected from the group consisting of an operation mode for reproducing the voice information corresponding to the nondisplayed state that the image display portion does not display any images, an operation mode for reproducing all of the voice information corresponding to the use situation and an operation mode for not reproducing any voice information in the voice reproducing portion.

10. A projection type display device, comprising:
an image display portion for displaying images by projection;
a memory portion for storing a voice information recorded preliminarily, associating the voice information with an use situation;
a voice reproducing portion for reproducing the voice information; and
a control portion for detecting an use situation of each portion if it judges that the image display portion is in a state of not being able to display the images, and simultaneously if the voice information corresponding to the use situation exists, for obtaining the voice information corresponding to the detected use situation from the memory portion and reproducing the information in the voice reproducing portion.

11. A projection type display device according to claim 10, wherein the control portion changes a reproducing volume of the voice information reproduced in the voice reproducing portion dependent on the driving situation of a fan for cooling the image display portion.

12. A projection type display device according to claim 10, wherein the control portion detects a volume of ambient noise and changes a reproducing volume of the voice information reproduced in the voice reproducing portion dependent on the volume of ambient noise.

13. A projection type display device according to claim 10, wherein the memory portion having the voice information of plural languages, and the control portion, when it obtains the voice information of plural languages from the memory portion, obtains a voice information of the language selected by language setting in OSD (On Screen Display) which the image display portion displays so as to be overlapped with the images.

14. A projection type display device according to claim 10, wherein the memory portion stores the voice information received from the outside, associating the voice information with the use situation.

15. A projection type display device according to claim 10, wherein the memory portion stores the voice information associated with the preparatory state of the image display portion.

16. A projection type display device according to claim 10, wherein the memory portion stores the voice information associated with the ending state of the image display portion.

17. A projection type display device according to claim 10, wherein the memory portion stores the voice information associated with the existence or nonexistence of the input signal of the image display portion.
